(19) United States
(12) Patent Application Publication
(10) Pub. No.: US 2005/0024258 A1
(43) Pub. Date: Feb. 3, 2005

(54) Method and apparatus for recognizing predetermined particular part of vehicle

(76) Inventors: Keiji Matsuoka, Kariya-shi (JP); Hideki Kitagawa, Aichi-ken (JP); Hirofumi Anma, Takahama-shi (JP); Atsushi Kawakubo, Toyota-shi (JP); Tomoya Kawasaki, Aichi-ken (JP)

Correspondence Address: POSZ & BETHARDS, PLC, 11250 ROGER BACON DRIVE, SUITE 10, RESTON, VA, 20190, US

(21) Appl. No.: 10/901,297

(22) Filed: Jul. 29, 2004

(30) Foreign Application Priority Data
Jul. 30, 2003 (JP) 2003-283139

(51) Int. Cl. G01S 13/93

(52) U.S. Cl. 342/70; 342/71; 342/72; 342/107

(57) ABSTRACT

An on-vehicle apparatus for recognizing objects is provided. The apparatus comprises a transmission/reception unit, detection unit, estimation unit, and specification unit. The transmission/reception unit transmits a medium wave toward a desired directional range from the vehicle and receives reflected waves of the medium wave and the detection unit detects objects existing in the desired directional range on the basis of the reflected wave. The estimation unit estimates a possibility that each detected object has been detected based on a reflected wave from a first part (e.g., cabin) of a further vehicle other than a second part (e.g., rear part) of the further vehicle, the first part being other than the second part that is the closest in distance to the apparatus-mounted vehicle. The specification unit specifies the second part as an object to finally be recognized of the apparatus-mounted vehicle depending on an estimated result by the estimation unit.

### BACKGROUND OF THE INVENTION

1. Technical Field

The present invention relates to a method and apparatus for recognizing a vehicle preceding a vehicle on which the apparatus is mounted, and in particular, to the method and apparatus for recognizing a particular part, such as a rear part (i.e., object) of each preceding vehicle by making use of a radar device.

2. Related Art

In recent years, much attention has been paid to research for creating a comfortable and safe traffic environment among researchers of automobiles and others.

One type of apparatus dedicated to such research has been represented by Japanese Patent laid-open publication No. 2002-22827, in which a technique for recognizing objects is exemplified. In this publication, this technique is realized by a radar device, which transmits a radio wave toward certain directions to receive waves reflected from various objects existing ahead of the vehicle on which the radar device is mounted.

This apparatus detects the intensities of the reflected waves, and uses the detected intensities to determine whether or not there are one or more objects to be detected ahead of the first vehicle. To be specific, the radar device according to the above publication removes, from all electronic reception signals created from the reflected waves, some reception signals of which intensities are less than a predetermined threshold. This threshold, which is set in advance, takes a value that corresponds to a signal intensity regarded as being obtained when a transmitted radio wave is reflected by a vehicle in a normal state. In this radar device, the remaining reception signals are then subjected to recognition processing for objects.

One mode of this reception processing can be realized as follows. The threshold is previously given corresponding to the intensity of a signal reflected in a normal state by a reflector attached to the rear side of a vehicle running ahead. This threshold is applied to the removal processing of signals, where reception signals coming from areas other than the reflector on the vehicle's rear side are removed from those to be subjected to the recognition processing.

However, the foregoing conventional object recognizing technique has still suffered a problem of erroneously recognizing objects. Such a problem is, by way of example, due to the cabin of a vehicle. In the case that a first vehicle on which the radar device is mounted runs after a second vehicle (such as a truck) to be targeted running on a straight road, the part of driver's seat (hereinafter referred to as “cabin”) of the second vehicle is behind the bed thereof when viewing from the first vehicle. Hence, in this case, the reception signals created from received waves reflected by the cabin of the preceding second vehicle becomes lower in intensity. Due to this fact, such signals of lower intensities can be removed well.

In contrast, this removal will not be effective in various particular occasions where the road is curved or a large-scale vehicle (the second vehicle) such as trucks run ahead along the lane adjacent to a lane along which the radar-device-mounted vehicle (the first vehicle) runs. In such exampled cases, the cabin of the preceding vehicle (the second vehicle) will not be behind the bed thereof, but there are some cases where reflected waves of higher intensities are received from the cabin as well as the reflector on the rear side of such a large-size vehicle. If such signal reception happens, the conventional object recognizing technique is no longer accurate, because objects to be targeted are detected based on the intensities of signals processed from such reflected waves. For example, the radar device on the following vehicle would determine that two vehicles run in series along the adjacent lane. That is, it is no longer difficult to accurately detect vehicles such as large-size trucks running ahead.

### SUMMARY OF THE INVENTION

The present invention has been made with due consideration to the foregoing difficulty, and an object of the present invention is to provide an apparatus and method of recognizing objects running ahead in an accurate manner.

In order to achieve the object, there is provided an apparatus for recognizing an object, the apparatus being mounted on a vehicle (i.e., concerned vehicle). The apparatus comprises a transmission/reception unit, detection unit, estimation unit, and specification unit. The transmission/reception unit transmits a medium wave toward a desired directional range from the vehicle and receives reflected waves of the medium wave. The detection unit detects one or more objects existing in the desired directional range on the basis of the reflected wave, the objects reflecting the medium wave to form the reflected waves. The estimation unit estimates a possibility that each of the detected object is detected based on a reflected wave from a first part (e.g., cabin) of a second vehicle other than a second part (e.g., rear part) of the second vehicle, the first part being other than the second part that is the closest in distance to the first vehicle. The specification unit specifies the second part as an object to finally be recognized of the second vehicle depending on an estimated result by the estimation unit.

Hence, in the object recognizing apparatus, an object to be determined, which is detected by the detecting unit, is allowed to estimate a possibility that the object has been detected on a wave reflected from the cabin or others (i.e., the first part) of a large-scale vehicle (i.e., the second vehicle) other than the rear part (i.e., the second part) thereof. When it is determined that the possibility is higher, the object to be determined is removed from the processing, for example. In contrast, when it is determined that the possibility is lower (i.e., an accuracy that the object has been detected on a wave reflected from the cabin is higher), the object which has now been detected is treated as being an object to finally be recognized. It is therefore possible to treat only the objects reflected from the second part (i.e., rear part) which is desired, so that vehicles preceding the concerned vehicle) can be recognized in an accurate and reliable manner.

The foregoing basic configuration can be developed into various other modes, some of which are as follows.

It is preferred that the detection unit is configured to detect, as the objects existing in the desired direction range, a plurality of objects and to detect a distance from the first vehicle to the detected object, a relative speed to the detected object compared to the first vehicle, and a lateral position of the detected object from the first vehicle to calculate a distance, a difference in a relative speed, and a difference in a lateral position between two objects of the plurality of objects and the estimation unit includes a first determining unit determining the possibility, as to each of the plurality of objects, on the basis of at least one of the distance, the difference in the relative speed, and the difference in the lateral position between the two objects.

Preferably, the estimation unit is configured to remove, from the plurality of objects detected by the detection unit, an object whose speed is less than a predetermined value.

It is also preferred that the first determination unit is configured to use, in the estimation, the difference in the relative speed between two objects of the plurality of objects so that the smaller the difference in the relative speed, the higher the possibility to the one of the plurality of objects.

The first determination unit may also be configured to use, in the estimation, the difference in the lateral position between two objects of the plurality of objects so that the smaller the difference in the lateral position, the higher the possibility to the one of the plurality of objects.

Moreover, the first determination unit may also be configured to use, in the estimation, the distance between two objects of the plurality of objects so that, when the distance is less than a predetermined distance, the possibility to the one of the plurality of objects is high.

It is also preferred that the first determination unit is configured to determine whether or not each of the plurality of objects satisfy predetermined determining conditions in relation to the distance, the difference in the relative speed, and the difference in the lateral position between the two objects of the plurality of objects.

In this case, by way of example, the estimation unit includes a second determination unit determining, to estimate the possibility, whether or not each of the plurality of objects meets predetermined determining conditions showing positional relationships between the first vehicle and each of the plurality of objects when the first estimation unit determines that an object of the plurality of objects fails to meet the determining conditions of at least one of the distance, the difference in the relative speed, and the difference in the lateral position and the specification unit is configured to specify the object as the object to finally be recognized, when the second determination unit determines that the object meets the determining conditions showing positional relationships between the first vehicle and each of the plurality of objects.

In order to achieve the foregoing object, as another aspect of the present invention, there is also provided a method for recognizing an object, which is able to provide the similar or same advantages to or as the above. Specifically, there is provided a method for recognizing an object viewed from a vehicle, comprising: transmitting a medium wave toward a desired directional range from the vehicle and receiving reflected waves of the medium wave; detecting one or more objects existing in the desired directional range on the basis of the reflected wave, the objects reflecting the medium wave to form the reflected waves; estimating a possibility that each of the detected object is detected based on a reflected wave from a first part of a second vehicle other than a second object of the second vehicle, the first part being other than the second part that is the closest in distance to the viewing vehicle; and specifying the second part as an object to finally be recognized of the second vehicle depending on an estimated result in the estimating step.

Various other configurations and advantages thereof will be made clear in the accompanying drawings and the descriptions in the embodiments.

### BRIEF DESCRIPTION OF THE DRAWINGS

Other objects and aspects of the present invention will become apparent from the following description and embodiments with reference to the accompanying drawings in which:

FIG. 1 is a block diagram showing the entire electrical configuration of a vehicle-to-vehicle distance control system to which an object recognizing apparatus according to an embodiment of the present invention is applied;

FIG. 2 is a block diagram showing the electrical configuration of a radar device employed by the control system according to the embodiment;

FIG. 3A exemplifies a reception signal produced from a received electromagnetic wave, which is a reflected wave of a transmitted electromagnetic wave;

FIG. 3B exemplifies a signal produced by a mixer under mutual mixing of electrical signals corresponding to the transmitted and received electromagnetic waves;

FIG. 4 illustrates the principle of measuring a direction of a wave-reflecting object as the basis for a concerned vehicle, the measurement being carried out by the radar device;

FIG. 5 illustrates determining conditions A to C used in processing for adding/subtracting the count of a cabin counter, the conditions being used in the embodiment;

FIG. 6 illustrates determining conditions D to F used in processing for adding/subtracting the count of a cabin counter, the conditions being used in the embodiment;

FIG. 7 is a flowchart showing determining processing employed by the embodiment;

FIG. 8 is a flowchart showing adding/subtracting processing of the count of the cabin counter according to the embodiment;

FIG. 9 is a flowchart explaining processing for determining whether or not object data should be handed to a computer serving as a calculation unit;

FIG. 10 explains a positional relationship between a directional detection range of the radar device and the rear part and cabin of a large-scale vehicle;

FIG. 11 explains a region B indicative of the determining conditions D to F used by the determining processing in the embodiment;

FIG. 12 is a partial flowchart showing a feature of a modification according to the embodiment; and

FIG. 13 is a flowchart showing processing for determining whether or not object data should be handed to a computer serving as a calculation unit, the processing being carried out in the modification.

### DETAILED DESCRIPTION OF PREFERRED EMBODIMENTS

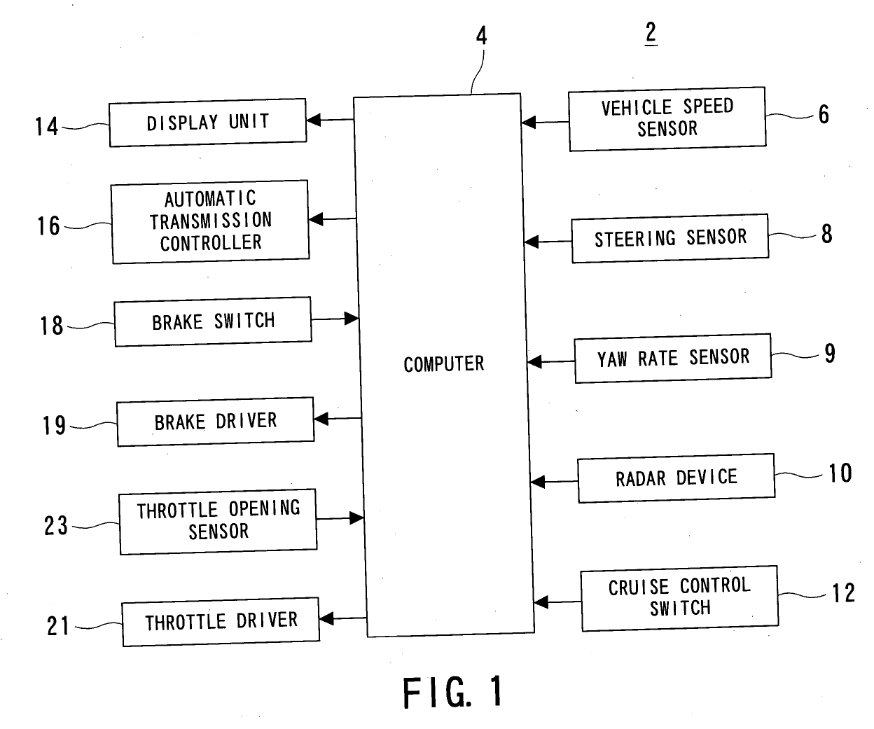

In connection with FIGS. 1 to 11, a preferred embodiment of both an object recognizing apparatus and an object recognizing method according to the present invention will now be described.

The present embodiment provides an object recognizing apparatus and an object recognizing method, which are reduced into practice in a vehicle-to-vehicle distance control system used for constant speed control of vehicles. During the constant speed control, the control system allows the speed of a following vehicle (on which the system is mounted, which corresponds the first vehicle according to the present invention) to keep a predetermined vehicle-to-vehicle distance to a preceding vehicle (corresponding to the second vehicle of the present invention) which runs immediately ahead when the following vehicle begins keeping track of the preceding vehicle.

FIG. 1 shows the overall configuration of the vehicle-to-vehicle distance control system 2. This system 2 is provided with, as one of the primary components, a computer 4 communicably connected to various input/output devices. Such input/output devices include a vehicle speed sensor 6, steering sensor 8, yaw rate sensor 9, radar device 10, cruise control switch 12, display unit 14, automatic transmission controller 16, brake switch 18, brake driver 19, throttle driver 21, and throttle opening sensor 23.

Though not shown in the figure, the computer 4 is provided with input/output (I/O) interfaces and various drive circuits for the output devices. The configuration of the computer 4 has the ordinarily used configuration, omitting it from being explained in detail. The computer 4 is in charge of performing control of a vehicle-to-vehicle distance to a preceding vehicle and performing constant speed control for making the vehicle run at a predetermined speed.

The vehicle speed sensor 6 is configured to detect a signal indicating the rotation speed of wheels and to provide the computer 4 with the detected signal. The steering sensor 8 is formed to detect changed amounts in a steered angle of a steering wheel. The detected changed amounts are subjected to detection of relative steering angles. Signals indicative of the detected steering angles are then sent to the computer 4. Moreover, the yaw rate sensor 9 has the configuration of detecting an angular velocity about the vertical axis through the vehicle and of providing the computer 4 with a signal in relation to the detected angular velocity.

The cruise control switch 12 is equipped with five push switches consisting of a main switch, a set switch, a resume switch, a cancel switch, and a tap switch.

The main switch is used to start the cruise control (control for constant speed run), during which the vehicle-to-vehicle distant control is carried out. The set switch receives a signal indicating a current speed of the vehicle, when being pushed, and memorizes the speed as a vehicle speed to be targeted. After the vehicle speed to be targeted is set, the constant speed run control is carried out.

The resume switch is used to return the current speed of the vehicle to a target speed thereof in response to a push operation, in cases where the vehicle is not in the constant speed run control but the target vehicle speed is set and memorized. Further, the cancel switch is a switch to stop the constant speed run control which is now under operation. When the cancel switch is pushed down, processing for stopping the control begins. The tap switch is placed to give the system a vehicle-to-vehicle distance to be targeted to a preceding vehicle and the target distance can be set depending on user's desire as long as the distance is within a predetermined range.

Though not shown, the display unit 14 is composed of devices for displaying a setting vehicle speed, vehicle-to-vehicle distance, and sensor trouble. The setting vehicle speed displaying device is assigned to display of a setting vehicle speed for the constant speed run control and the vehicle-to-vehicle distance displaying device is assigned to display of a vehicle-to-vehicle distance to a preceding vehicle using results measured by the radar device 10. Further, the sensor trouble displaying device is arranged to display occurrence of troubles of various sensors including the vehicle speed sensor 6.

The automatic transmission controller 16 is configured to respond to commands from the controller 4 so that the automatic transmission selects its gear position required to control the speed of a concerned vehicle. The brake switch 18 is configured to detect an amount of a driver's depressing operation toward a brake pedal, while the brake driver 19 is formed to control braking pressure on commands from the computer 4.

The throttle driver 21 is in charge of adjusting of the opening of a throttle valve in response to commands that the computer 4 gives for output control of an internal combustion engine. Moreover, the throttle opening sensor 23 has the configuration of detecting the throttle valve.

The computer 4 is equipped with a not-shown power switch. When the power switch is turned on, the computer 4 is powered to start predetermined processing. The computer 4 is thus able to perform various types of control including the vehicle-to-vehicle distance control and the constant speed run control.

The radar device 10, which is also mounted on the vehicle to provide the computer 4 with information about running states of preceding vehicles, is composed of for example a radar device of FM-CW type, which has been well known. This radar device 10 is mounted on the front grille or other portion near thereto of a concerned vehicle (i.e., the first vehicle according to the present invention). Hence the radar device 10 is able to radiate electromagnetic wave such as extremely-high frequency wave ahead of the concerned vehicle and receive the retuned electromagnetic wave. Signals processed from the returned electromagnetic wave then undergo processing for obtaining a distance and a relative speed to each wave-reflecting object and a direction of the concerned vehicle for finally recognizing a preceding vehicle running ahead of the concerned vehicle. This processing is also carried out by a processing unit incorporated in the radar device 10, so that data indicative of the distance and relative speed to the recognized preceding vehicle and a lateral position calculated from the detected distance and direction is produced. The lateral position is defined as a position measured from the center of a wave-reflecting object to be determined in the lateral direction of a concerned vehicle.

The produced data, that is, object data, is then provided to the computer 4.

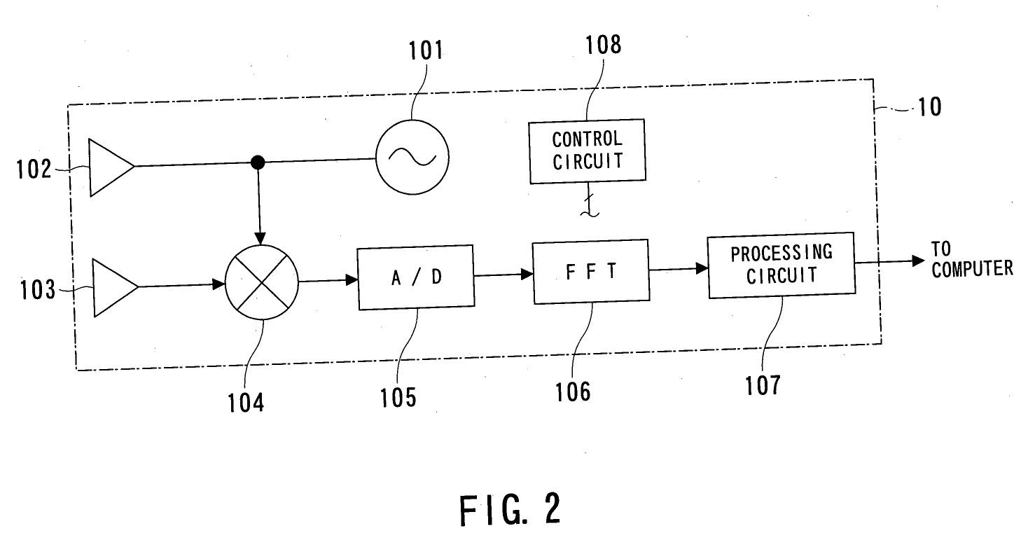

Referring to FIG. 2, the radar device 10 will now be detailed in terms of its internal configuration.

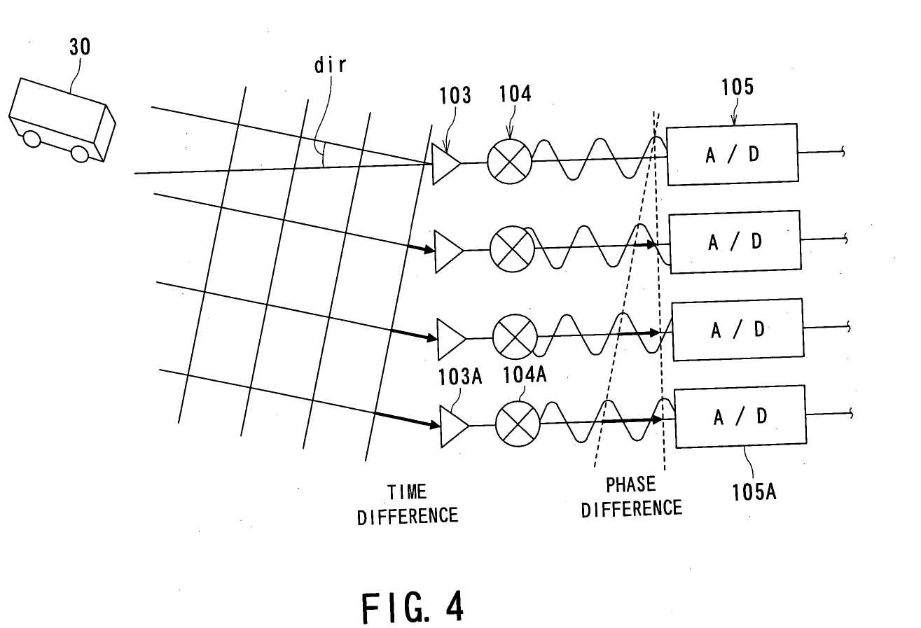

As shown in FIG. 2, the radar device 10 is provided with an oscillator 101, a transmission antenna 102, a reception antenna 103, a mixer 104, an A/D converter 105, an FFT 106, a processing circuit 107, and a control circuit 108 in charge of entirely controlling the radar device 10. Of these components, the reception antenna 103, mixer 104, and A/D converter 105 compose a multiple channel type of reception system, as shown in FIG. 4. That is, each of the reception antenna 103, mixer 104, and A/D converter 105 consists of a plurality of components (i.e., a plurality of reception antenna elements 103A, a plurality of mixing circuits 104A, and a plurality of A/D converter circuits 105A).

The oscillator 101 is for example composed of a voltage controlled oscillator capable of changing the frequency of a signal to be oscillated by controlling the level of voltage applied thereto. The signal frequency is modulated to oscillate within a predetermined frequency width whose central frequency is given to a predetermined value.

The transmission antenna 102 is used to radiate an electromagnetic wave (i.e., a transmission wave) ahead of the concerned vehicle. The reception antenna 103, which is composed of a plurality of reception antenna elements 103A, receives electromagnetic waves reflected from various objects responsively to radiating the electromagnetic wave by the transmission antenna 102. Each mixing circuit 104A of the mixer 104 produces a beat signal by mixing a signal (i.e., a signal to be transmitted) produced by the oscillator 101 with a signal (i.e., a received signal) received by the reception antenna element 103.

Each A/D converting circuit 105A of the A/D converter 105, which intervenes between each mixing circuits 104A of the mixer 104 and the FFT 106, converts the analog-quantity beat signal produced by the mixer 104 into a digital-quantity signal. When receiving the beat signal in time domain, the FFT 106 convert it to power spectrum data in frequency domain. The power spectrum data is sent to the processing circuit 107, where the data is used to calculate both a distance and a relative speed to each particular part (object) of a vehicle (, which is for example the cabin and the rear part thereof; hereinafter referred to as wave-reflecting object) reflecting the electromagnetic wave that has been transmitted and a direction of the wave-reflecting object with respect to the concerned vehicle.

The processing circuit 107 is configured to use data of both the distance to each wave-reflecting object and the direction thereof to compute a lateral position of the wave-reflecting object to the concerned vehicle. The processing circuit 107 is also configured to produce, in response to the computation, “object data” consisting of data indicative of a distance to each wave-reflecting object, a relative speed to each wave-reflecting object and a lateral position of each wave-reflecting object to the concerned vehicle. The “object data,” which has thus been produced, is sent to the computer 4.

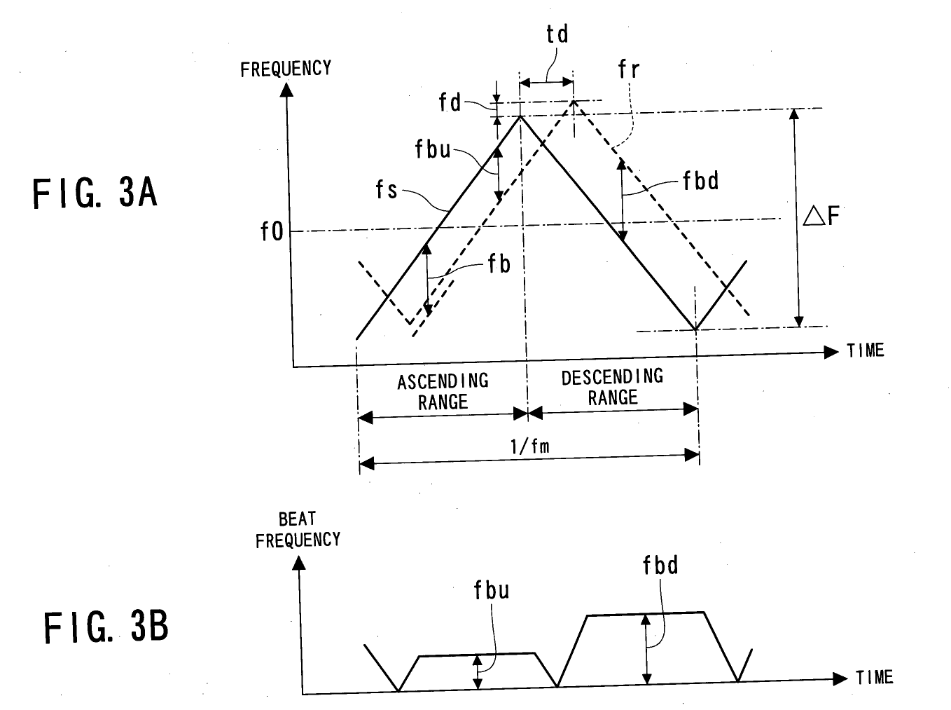

In connection with FIGS. 3A and 3B to 6, the measurement principle of the radar device 10 will now be described.

FIG. 3A is an illustration showing the situation where an electromagnetic wave is transmitted as a transmission wave fs and a reflected electromagnetic wave of the transmission wave fs is received as a reception wave fr. As shown in FIG. 3A, the transmission wave fs is repeatedly radiated from the transmission antenna 102 at intervals of 1/fm, during each interval of which the transmission wave fs is subjected to frequency modulation within a modulation width of AF whose central frequency is f0.

The transmission wave fs is reflected by various objects existing within a field of its radiation (i.e., detection range) and each reflected wave of the transmission wave fs is received as the reception wave fr by the reception antenna elements 103A, as explained above. Compared to the transmission wave fs, the reception wave fr has a delay of time td and a shift of frequency fd. The radar device 10 according to the present embodiment uses both the time delay td and the frequency shift fd to compute both a distance and a relative speed to each wave-reflecting object.

In cases where the relative speed of a concerned vehicle to a wave-reflecting object is zero, a delay of time td corresponding to a distance to the wave-reflecting object is caused in a reflected wave of the transmission wave fs, when compared to the transmission wave fs. Hence, based on this time delay td, the distance to the targeted wave-reflecting object can be calculated.

On the other hand, the foregoing frequency shift fd can be used to obtain information about the relative speed. To be specific, this owes to the fact that the frequency shift fd is caused due to a Doppler effect of the electromagnetic wave. When there is a difference in relative speed between a concerned vehicle and a wave-reflecting object, the transmission wave fs transmitted from the concerned vehicle is subjected to, at the wave-reflecting object, a change in the amount of frequency shift fd depending on the amplitude of the relative speed. It is thus possible to use the amount of frequency shift fd to compute the relative speed.

FIG. 3B explains two beat signals that each mixing circuit 104A produces by mixing the transmission wave fs with the reception wave fr. As illustrated, one beat signal has a beat frequency fbu, which is an amount of frequency shift between ascending ranges of the transmission and reception waves fs and fr, while the other beat signal has a beat frequency fbd, which indicates an amount of frequency shift between descending ranges of the transmission and reception waves fs and fr.

Using these two beat frequencies fbu an fbd makes it possible to provide both of a frequency fb corresponding to the foregoing distance and a further frequency fd corresponding to the amplitude of the foregoing relative speed, as below.
Frequency fb corresponding to distance=[ABS(fbu)+ABS(fbd)]/2 (1)
Frequency fd corresponding to relative speed=[ABS(fbu)−ABS(fbd)]/2 (2)
In these formulas, a reference ABS shows of an absolute value.

Further substituting these frequencies fb and fd into the following formulas (3) and (4) enables both a distance and a relative speed to an wave-reflecting object to be calculated. In the following formulas, C denotes the speed of light.
Distance=C/(4·ΔF·fm)·fb (3)
Relative speed=(C/2·f0)−fd (4)

In connection with FIG. 4, the principle for measuring the direction of each wave-reflecting object (vehicle's member) to a concerned vehicle will now be explained. As shown in FIG. 4, reflected waves of the electromagnetic wave transmitted by the transmission antenna 102 are received by the plural antenna elements 103A of the reception antenna 103, and each of the received waves undergoes calculation of the direction of each wave-reflecting object to the concerned vehicle.

The plural antenna elements 103A of the reception antenna 103 are disposed in an array on a vehicle. Thus, if a preceding vehicle is located right to the lateral direction of a concerned vehicle, there is caused almost no difference in arrival time of the reflected waves at the plural antenna elements 103A for reception. At the A/D converting circuits 105A, which composes the A/D converter 105 and each receives each beat signal, there is almost no difference in phases among the beat signals, because the beat signals are produced from the reflected waves received at the almost same time instant.

In contrast, as illustrated in FIG. 4, there are many cases where a preceding vehicle 30 is not lactated right to the lateral direction of the concerned vehicle. In such a case, when the reception of plural reflected waves at the plural reception antenna elements 103A experiences differences in the distance between each reception antenna element 103A and the preceding vehicle 30 reflecting the transmission wave. Hence, at the respective reception antenna elements 103A, there are caused considerable (i.e., not negligible) amounts of differences in the arrival time instants of the reflected waves.

These differences in the arrival time instants are reflected in the differences in phases of the beat signals to be fed to the respective A/D converting circuits 105A. It is therefore possible to use those phase differences to acquire information indicating the direction (noted as dir in FIG. 4) of the preceding vehicle 30 to the concerned vehicle.

The computer 4 is configured to perform various types of computation on the basis of predetermined software programs stored in advance in an incorporated or external memory of the computer 4. The various types of computation are as follows.

The computer 4 uses a signal from the steering sensor 8 to calculate a steered angle, uses a signal from the yaw rate sensor 9 to calculate a yaw rate, and uses a signal from the vehicle speed sensor 6 to calculate a speed of a concerned vehicle on which this control system is mounted. Pieces of information concerning the steered angle, yaw rate, and vehicle speed are fed to the radar device 10, where the radar device 10 uses the received information to calculate a turning radius R on which the concerned vehicle is about to turn or in a turning operation.

Incidentally, the turning radius R can be obtained in other various ways. For example, imaging means such as CCD (Charge Coupled Device) camera may be used. The CCD camera is mounted on a vehicle to image, at intervals, one or more cruising lanes extending before the concerned vehicle and images thus-taken are subjected to recognition of the cruising lanes and estimation of a turning radius R of the concerned vehicle. If a vehicle is equipped with a navigation system with a GPS (Global Positioning System) that uses waves from the satellites, the navigation system may be used. In this navigation system, the GPS allows a current position of the concerned vehicle to be found. Hence the current position is made reference to map data in the navigation system itself so as to obtain data showing the turning radius R.

Further, of the detected distance, relative speed, and direction, the radar device 10 uses both the direction and the distance to calculate a central position coordinate (X, Y) of a vehicle preceding the concerned vehicle in the XY orthogonal coordinate system, in which the origin (0, 0) is positioned at the center of the radar device 10 on the concerned vehicle and the lateral and longitudinal directions of the concerned vehicle are assigned to the X— and Y-axes, respectively. In addition, when the turn radius R is smaller than a predetermined value (e.g., 1000 m), it is determined by the radar device 10 that a preceding vehicle runs along a curved road, not a straight road. And the central position coordinate (X, Y) is applied to the turning radius R to convert the coordinate to a new central position coordinate of the preceding vehicle which should be obtained on the assumption that the preceding vehicle runs straight.

The object data including the converted preceding vehicle's central position coordinate and the relative speed is then fed to the computer 4. When the converted central position coordinate falls within an abnormal range, data notifying that a malfunction has occurred is sent to the computer 4. Responsively, the computer 4 sends, to the sensor-malfunctioning display of the display unit 14, a command signal to notify a user of having caused an accident.

Using the object data transmitted from the radar device 10, the computer 4 decides which preceding vehicle should be controlled with respect to a vehicle-to-vehicle distance. On completion of decision of a preceding vehicle which should be put under the control of the vehicle-to-vehicle distance, the computer 4 uses information in relation to both a distance and a relative speed to the chosen preceding vehicle, a speed of the concerned vehicle, a setting state of the cruise control switch 12, and a depressed state of the brake switch 18 in order to output control signals for adjusting the distance to the preceding vehicle to the brake driver 10, throttle driver 21, and automatic transmission controller 16. Concurrently, to make the display unit 14 notify the driver (user) of the current control situations, the controller 4 provides the display unit 14 with necessary display signals.

In addition, the controller 4 engages in control of a throttle opening by driving the throttle driver 21, control of gear positions of the automatic transmission by operating the automatic transmission controller 16, and/or control of braking pressure by driving the brake driver 19. These various kinds of control allow the distance between the concerned vehicle and a preceding vehicle to keep a targeted distance. The display unit 14 is used to present information about the control for the vehicle-to-vehicle distance in real time.

By the way, the radar device 10 according to the present embodiment is configured to determine whether or not the object data should not be fed to the computer 4, prior to feeding the object data to the computer 4. If it is determined that the object data should not be fed to the computer 4, the radar device 10 temporarily stops feeding the object data to the computer 4.

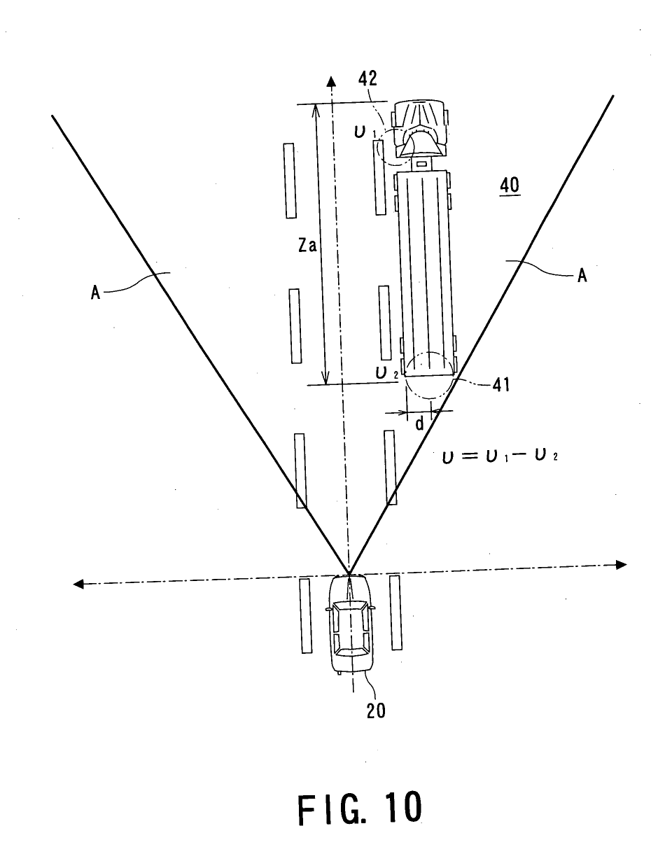

This temporary stop of data supply stems from the following reason. For example, as shown in FIG. 10, assume that a large-scale vehicle 40 such as truck or trailer runs along a traffic lane adjacent to that along which a concerned vehicle 20 runs and both the rear part 41 and the cabin of the large-scale vehicle 40 reside within a range A (detection range) in which the radar device 10 is able to detect objects. In this situation, a transmission wave radiated from the radar device 10 may be reflected by not only the rear part 41 of the vehicle 40 but also a corner and portions near thereto intervening between the rear and a side of the cabin of the vehicle 40. There are some cases in which the radar device 10 receives two waves reflected by those two portions 41 and 42. In such cases, though the large-scale vehicle 40 runs along the traffic lane adjacent to the concerned vehicle 20, the detection is made erroneously such that two vehicles run in series along the adjacent lane.

In the present embodiment, however, such an erroneous detection is removed steadily. In other words, the radar device 10 uses both the central position coordinate and the relative speed, which are included in the object data, so as to estimate a possibility that a wave-reflecting object resulting from the object data is recognized on a reflected wave coming from the two portions 41, 42. If it is determined that there is a high possibility that the wave-reflecting object is recognized based on the reflected wave coming from the rear part 41 of the cabin of the large-scale vehicle 40, object data indicating this wave-reflecting object is stopped from being fed to the computer 4.

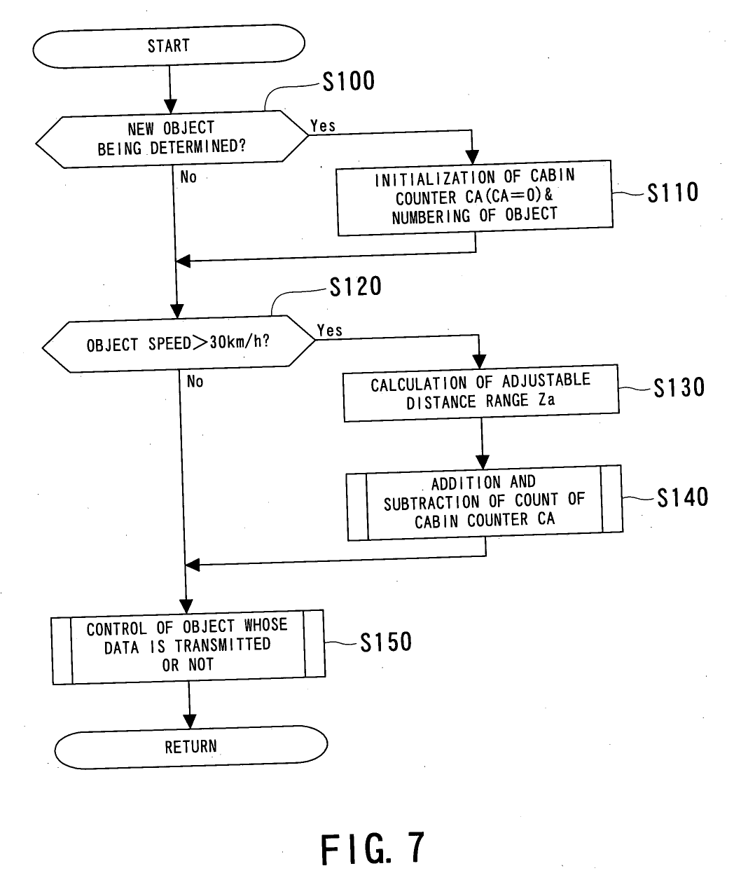

Referring to FIGS. 7-9, the processing for determining wave-reflecting objects will now be described, which is characteristic of the present embodiment and carried out by the radar device 10.

In this determination processing, the radar device 10 is formed to cope with a plurality of wave-reflecting objects based on a predetermined program memorized. Specifically, in cases where the radar device 10 detects a plurality of wave-reflecting objects, the radar device 10 will specify a wave-reflecting object located farthest away from the concerned vehicle as the first object to be determined and perform the determination processing on the specified object. The determination processing is then shifted to another wave-reflecting object located second-largest in the distance to the concerned vehicle. That is, this processing is repeated every object in the descending order of the distance to the concerned vehicle.

The processing for this determination is repeated every 100 msec, for instance. As described later, a cabin counter CA is formed of a software counter to be made relevant to object data and a particularly selected value is added or subtracted to or from its count every time the processing is repeated.

First, at step S100 in FIG. 7, it is determined whether or not a wave-reflecting object given by object data has been newly detected. If the determination is YES at this step S110, the processing is shifted step S110, where the cabin counter CA made relevant to the object data given by this new wave-reflecting object is initialized and a reference (e.g., the number) for distinguishing this object from others is given. The processing is then shifted to step S120, to which the processing is also shifted as being determined NO at step S100.

At step S120, using a relative speed and a speed of a concerned vehicle, which are included in object data of the wave-reflecting object to be determined, a speed of the object is calculated and subject to determination of whether or not the calculated speed is over a predetermined speed (e.g., 30 km/h). When it is determined YES at step S120, the processing is shifted to steps S130 and S140, while it is determined NO at step S120, the processing moves to step S150.

To be specific, at step S130, an adjustable distance range Za is calculated by substituting the speed of the wave-reflecting object to be determined into the following formula.
Za=speed of wave-reflecting object (m/s)·0.5(s)+10(m) (5)
In this formula (5), the value 10 m is a representative of lower limits taking into the overall length of each large-scale vehicle.

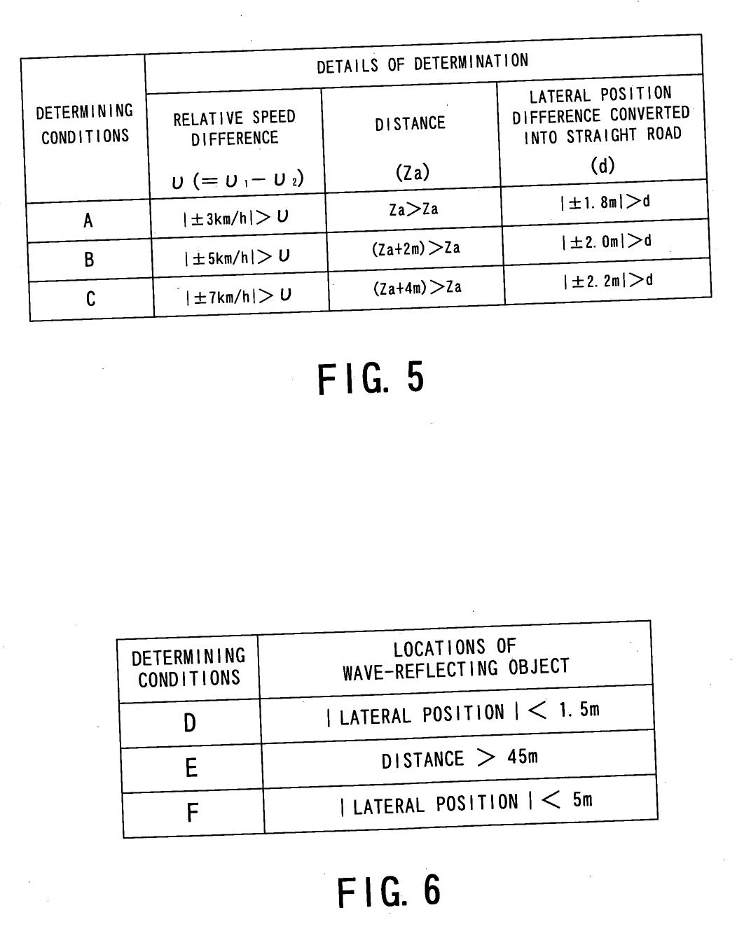

At step S140, a value is added or reduced to the count of the cabin counter, whose count provides a possibility that an object to be determined has been detected on a wave reflected from the cabin of a large-scale vehicle (or an accuracy that an object to be determined has been detected on a wave reflected from the rear part of a large-scale vehicle. The cabin counter adding/subtracting processing is directed to determination of whether or not a wave-reflecting object to be determined is located to satisfy determining conditions defined in FIG. 5 or determining conditions defined in FIG. 6. The determining conditions in FIG. 5 indicate relative running relationships between the wave-reflecting object to be determined and one or more other wave-reflecting objects located closer to the concerned vehicle than the object to be determined. The determining conditions in FIG. 6 indicate positional relationships between the concerned vehicle and one or more other wave-reflecting objects that do not satisfy any determining condition in FIG. 5.

In contrast, at step S150, the radar device 10 performs processing for selecting wave-reflecting object to be determined. The radar device 10 detects electromagnetic waves reflected from various objects including stationary objects, such as delineators attached on guard rails and reflecting plates on roads sides, not limited to the objects of a preceding vehicle. However, in the processing to be done from now on, it is not necessary for the radar device 10 to regard stationary objects as being objects to determine whether or not there is a possibility that each detected objects is the cabin of a large-scale vehicle.

In addition, it is frequent that the delineators are disposed along a road at intervals. If such delineators are subjected to the determination for wave-reflecting device without this pre-screening processing, there is a possibility of erroneous detection that there exists a wave-reflecting object (actually, a delineator) located nearer than a wave-reflecting object (also actually, a delineator) to be determined. In such a case, if truly done, the determination may reveal that there is a high possibility that the latter object, that is, the wave-reflecting object located farther away from the concerned vehicle, is an object recognized based on a reflected wave from the cabin of a large-scale vehicle.

Accordingly, at step S150, a wave-reflecting object subjected to the determination has a speed less than a predetermined speed (for example, 30 km/h; refer to step S120), such object is removed previously by the radar device 10 from objects to be determined. This previous removal (i.e., pre-screening processing) is able to avoid the stationary objects such as delineators from being erroneously decided as a large-scale vehicle's cabin.

FIG. 5 shows the determining conditions used for the processing for adding/subtracting the count of the cabin counter CA.

As shown, determining conditions A to C are defined and classified into several steps depending on the absolute values of three parameters consisting of differences of relative speeds, variable distance ranges Za, and differences of lateral positions. Of these determining conditions A to C, the determining condition A defines a group of those absolute values each of which is the smallest in each parameter. The determining condition B defines a group of those absolute values each being intermediate in each parameter. And the determining condition C defines a group of those absolute values each being the largest in each parameter. The possibility that a wave-reflecting object to be determined is the cabin of a large-scale vehicle depends on being classified into which one of the three determining conditions A to C. If the conditions meet the determining condition A of the smallest absolute value of each parameter, the possibility is the highest.

By contrast, if the conditions meet the determining condition C of the largest absolute value of each parameter, the possibility is the lowest. If meeting the determining condition B, the possibility is intermediate. That is, the possibility that the wave-reflecting object is a large-scale vehicle's cabin becomes higher, when advancing in the order of the determining conditions C, B, to A. A value depending on the largeness of the possibility is added to the count of the cabin counter CA, which thus shows a level indicative of the largeness of the above possibility.

Specifically, the above determining conditions are decided on the following estimation.

When a wave-reflecting object to be determined can be recognized based on a reflected wave from a large-scale vehicle's cabin, the estimation is made such that there is only a small difference in the relative speed between the wave-reflecting object resulting from the cabin and another wave-reflecting object recognized on a reflected wave from the rear part of the large-scale vehicle. Accordingly, as the difference in the relative speed between the wave-reflecting object to be determined and another one located nearer to the concerned vehicle than the object to be determined, it is determined that the possibility that the wave-reflecting object to be determined is recognized on a reflected wave from the cabin is higher.

Furthermore, when a wave-reflecting object to be determined can be recognized based on a reflected wave from a large-scale vehicle's cabin, it is estimated such that a difference in the lateral position between the wave-reflecting object resulting from the cabin and another wave-reflecting object recognized on a reflected wave from the rear part of the large-scale vehicle is within a limited range, because of the vehicle structure. Accordingly, as the difference in the lateral position between the wave-reflecting object to be determined and another one located nearer to the concerned vehicle than the object to be determined, it is determined that the possibility that the wave-reflecting object to be determined is recognized on a reflected wave from the cabin is higher.

In addition, if a plurality of vehicles, e.g., two vehicles run with one following the other (or another), a certain amount of vehicle-to-vehicle distance (i.e., the foregoing variable distance range Za) is kept between vehicles. In this running case, the variable distance range Za tends to be longer, as the speeds of those vehicles are increased. Hence, when a distance between a wave-reflecting object to be determined and another one located nearer than the object to be determined is less than a variable distance range Za, it is reasonable to determine that there is a higher possibility that the wave-reflecting object to be determined has been recognized on a wave reflected from a large-scale vehicle's cabin, not being a preceding one of those two vehicles.

As shown in the foregoing formula (5), with taking the overall length of a large-scale vehicle into consideration, a lower limit (for example, 10 m) is given to the variable distance range Za. Additionally, an upper limit (for example, 20 m) may be set to this variable distance range Za.

The determining conditions in FIG. 6 will now be explained. In the radar device 10, it is determined whether or not a wave-reflecting object to be determined falls into any of the determining conditions D to F shown in FIG. 6, which define positional relationships between the object to be determined and a concerned vehicle.

As shown in FIG. 6, based on the lateral position and the distance, the determining conditions D to F provide positional relationships between a wave-reflecting object to be determined and a concerned vehicle. If meeting the determining condition D or meeting the determining conditions E and F, it is determined that the wave-reflecting object to be determined is lower in the possibility that the object is a large-scale vehicle's cabin. In other words, a higher possibility that a wave-reflecting object currently subjected to the determination is, for example, the rear part of a passenger vehicle or a large-scale vehicle is estimated. When this estimation is done, the cabin counter CA assigned to the object which should be determined is subjected to decrementing the count.

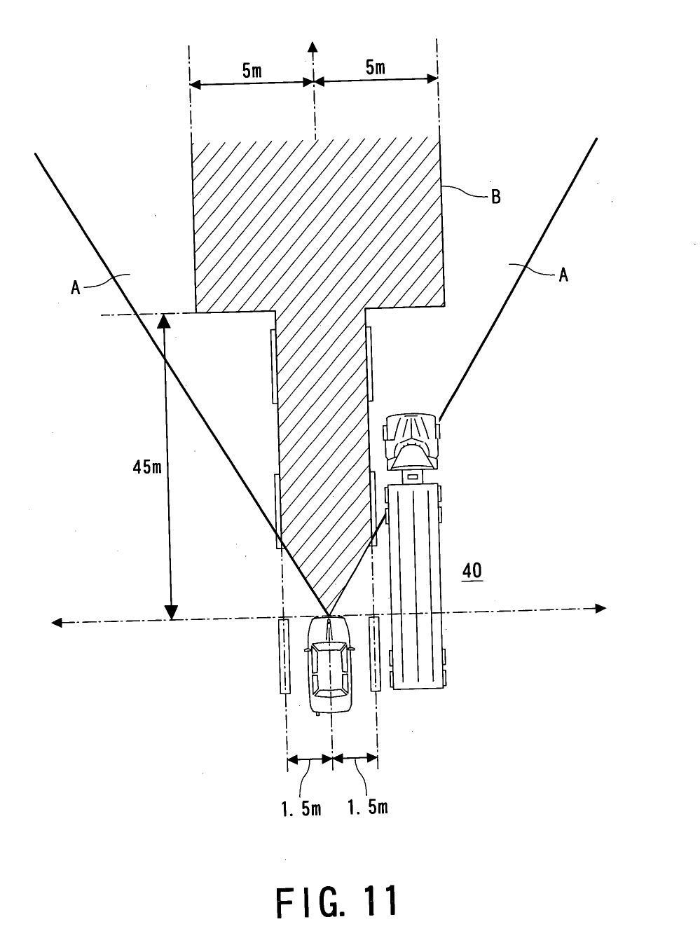

As to a wave-reflecting object that does not fall into any of the determining conditions A to C, there is a higher possibility that the object recognition is made using a wave reflected from the rear part of objects such as a passenger vehicle or a large-scale vehicle. Concurrently however, as shown in FIG. 11, there is a situation where the rear part of a large-scale vehicle exists outside the detection range A of the radar device 10, but only the cabin exists within the detection range A. In such situations, there is still left a possibility that a wave-reflecting object to be determined has detected based on an electromagnetic wave reflected from the cabin.

To distinguishably detect such situation, the determining conditions D to F shown in FIG. 6 are prepared. Under the determining conditions D to F, it is determined whether or not a wave-reflecting object to be determined positions in a central part of the detection range of the radar device 10. If this determination is affirmative, a probability that the object to be determined is a large-scale vehicle's cabin is low. In this case, the count of the cabin counter CA assigned to such a wave-reflecting object to be determined is reduced. The determining conditions in FIG. 6 regulate an area B shown in FIG. 11, which is included in the detection range A of the radar device 10.

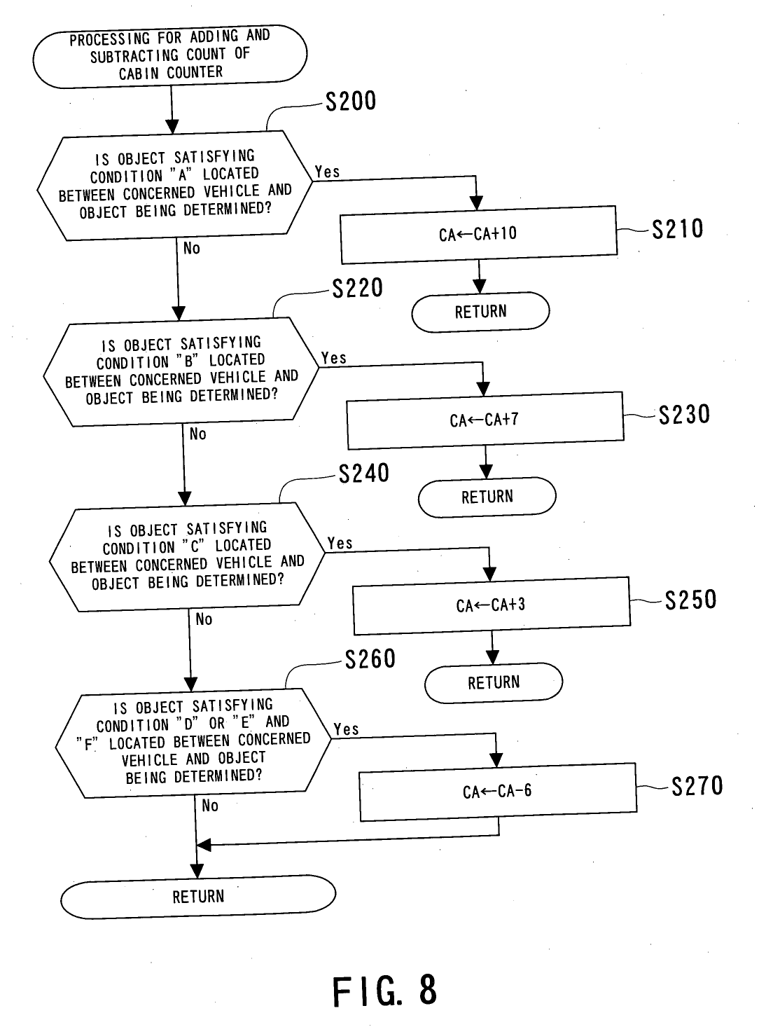

Referring to FIG. 8, the processing for adding and subtracting the count of the cabin counter CA will now be explained, which is carried out by the radar device 10 at step S140 in FIG. 7.

In general, when satisfying any of the determining conditions A to C shown in FIG. 5, the count of a cabin counter CA assigned to a wave-reflecting object to be determined is added and an added value depends on which determining condition is used (i.e., depending on the level of a possibility that the object under the determination is a large-scale vehicle's cabin). In contrast, when satisfying the determining condition D or the determining conditions E and F shown in FIG. 6, the count is reduced, as being there is a low possibility that the object under the determination is a large-scale vehicle's cabin.

At step S200 in FIG. 8, it is first determined whether or not there is another wave-reflecting object satisfying all of the parameters (i.e., relative speed difference, distance, and lateral positional difference) of the determining condition “A” between a concerned vehicle and a wave-reflecting object to be determined. When the determination at step S200 is affirmative (YES), the processing is shifted to step S210 to add a value of “10” to the count of a cabin counter CA assigned to the wave-reflecting object to be determined. The processing is then ended. In contrast, the determination at step S200 is negative (NO), the processing proceeds to step S220.

At step S220, it is further determined whether or not there is another wave-reflecting object satisfying all of the parameters of the determining condition “B” between the concerned vehicle and the wave-reflecting object to be determined. When the determination at step S220 is affirmative (YES), the processing is shifted to step S230 to add a value of “7” to the count of the cabin counter CA assigned to the wave-reflecting object to be determined, before ending the processing. In contrast, the determination at step S220 is negative (NO), the processing proceeds to step S240.

At step S240, it is further determined whether or not there is another wave-reflecting object satisfying all of the parameters of the determining condition “C” between the concerned vehicle and the wave-reflecting object to be determined. When the determination at step S240 is affirmative (YES), the processing is shifted to step S250 to add a value of “3” to the count of the cabin counter CA assigned to the wave-reflecting object to be determined, before ending the processing. In contrast, the determination at step S240 is negative (NO), the processing proceeds to step S260.

At step S260, it is determined whether or not there is another wave-reflecting object meeting the determining condition D or the combined determining conditions E and F between the concerned vehicle and the wave-reflecting object to be determined. When the determination at step S260 is affirmative (YES), the processing is shifted to step S270 to reduce a value of “6” to the count of the cabin counter CA assigned to the wave-reflecting object to be determined, before ending the processing. In contrast, the determination at step S240 is negative (NO), the processing is ended.

The foregoing processing is repeated at intervals by the radar device 10. Hence, even if two passenger vehicles temporarily run at the almost same speed with a lane-directional distance therebetween kept at an amount approximately equal to the overall length of a large-scale vehicle, it can be avoidable that one passenger vehicle temporarily preceding the other is erroneously detected as being a large-scale vehicle's cabin, because the cabin counter CA is reduced through the repeated processing.

On completing the cabin counter adding/subtracting processing at step S140 in FIG. 7, the processing is shifted to step S150 in FIG. 7, where it is further determined whether or not object data corresponding to the wave-reflecting object subjected to the cabin counter adding/subtracting processing is fed to the computer 4. In the present embodiment, this is referred to as processing for calculating data-transmitted object.

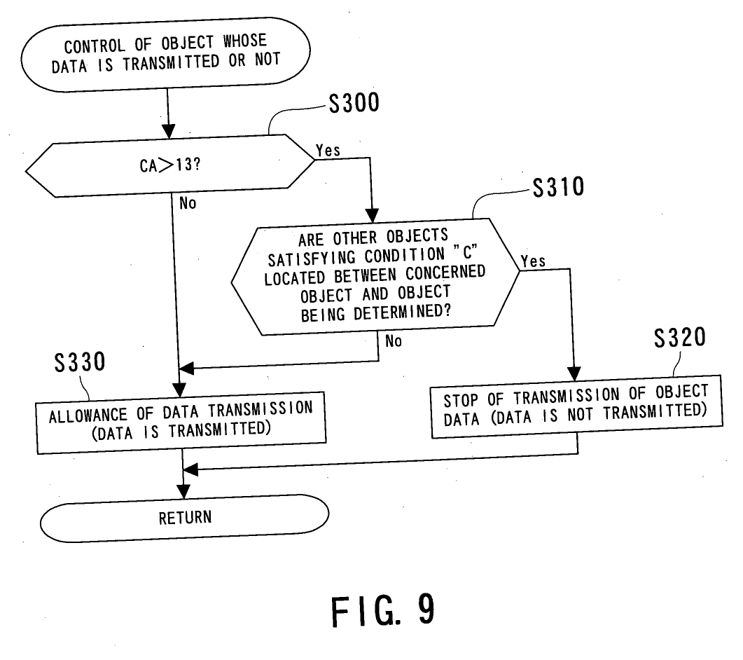

Referring to FIG. 9, the processing for calculation data-transmitted object will now be explained, which is carried out by the radar device 10 at step S150 in FIG. 7.

At step S300 in FIG. 9, the count of the cabin counter CA assigned to a wave-reflecting object to be determined is larger than a threshold of “13.” If it is determined YES at step S300, the processing is made to go to step S310. In contrast, if it is determined NO at step S300, that is, if it is determined that a wave-reflecting object to be determined is not a large-scale vehicle's cabin, the processing is shifted to step S330, where object data of the wave-reflecting object to be determined is allowed to be fed to the computer 4.

At step S310, it is again determined whether or not other wave-reflecting objects satisfying all of the parameters (i.e., relative speed difference, distance, and lateral position difference) of the determining condition “C” between the wave-reflecting object to be determined and the concerned vehicle. In cases where the determination is NO at step S310, it is found that the object to be determined is not a large-scale vehicle's cabin. As a result, the processing also proceeds to step S330 to send its object data to the computer 4.

By contrast, the determination at step S310 is YES, the recognition that the wave-reflecting object to be determined is a large-scale vehicle's cabin can be obtained. Hence the processing is shifted to step S320 to prohibit object data of the object to be determined from being fed to thee computer 4.

How to set an appropriate value to the threshold (e.g., 13) for the cabin counter CA is based on the following manner.

The threshold “13” used for the determination at step S300 is preferably given to an amount that does not permit the object data from being transmitted at step S320 through only one time of performance of the cabin counter adding/subtracting processing shown in FIG. 8.

This is for the purpose of not stopping transmission of object data, in cases where two vehicles run so as to temporarily meet the determining condition “A.” During the performance of the cabin counter adding/subtracting processing shown in FIG. 8, a value of “10” is added as a maximum to the cabin counter CA. It is easy to presume that a value of “10” is added to a cabin counter CA assigned to a new wave-reflecting object to be determined. In such a case, the threshold less than “10” is set, a wave-reflecting object to be determined undergoes affirmatively determination at step S300, so that the object data is prohibited from being sent to the computer 4 through only one time of performance of the cabin counter adding/subtracting processing. This is because the threefold serving as an appropriate comparative value with the count of a cabin counter CA is set to “13.” This makes it possible that the object data is prevented from being sent out, when two vehicles temporarily meet the determining condition “A.”

In this way, the vehicle-to-vehicle control system 2 according to the present embodiment uses information about object data assigned to each wave-reflecting object being determined to estimate a possibility that the wave-reflecting object is recognized on a wave reflected from a large-scale vehicle's cabin. In addition, the possibility is expressed qualitatively, that is, as a practical value. Therefore, if it is determined that the possibility is high compared to a predetermined value (criterion), the object data of the wave-reflecting object being determined is prohibited from being fed to the computer 4.

This makes possible to stop transmitting erroneous object data relating to a large-scale vehicle's cabin to the computer 4 to process such data. It is therefore possible for the computer 4 to misunderstand such erroneously detected object data as being data of an object to control a vehicle-to-vehicle distance. Practically, in the computer 4, the cabin of a large-scale vehicle can be avoided from being another vehicle. The vehicle-to-vehicle distance control on the erroneous object (i.e., a target to be controlled) can be avoided steadily.

In the foregoing embodiment, there are other various advantages.
(1) In the embodiment, a distance from a concerned vehicle to a wave-reflecting object (of a preceding vehicle) to be determined, a relative speed between the concerned vehicle and the wave-reflecting object, and a lateral position of the wave-reflecting position are used. Precisely, those parameters are converted to a distance, a difference in the relative speed, and a difference in the lateral position between two objects of a plurality of objects detected. Based on those converted parameters, the determination is made.

For example, if an object being determined has been detected on a wave reflected from a large-scale vehicle's cabin, an assumption can be made such that a difference in the relative speed to an object stemming from a large-scale vehicle's rear part is small. In addition, both a distance between objects and a difference in the lateral position are limited within a certain range, respectively, on account of the structure of a large-scale vehicle. It is thus useful to use those parameters in estimating the possibility, ensuring that the possibility is estimated more accurately.
(2) In the foregoing embodiment, wave-reflecting objects whose speeds are less than a predetermined value are previously removed from a group of objects to be determined. This allows the apparatus mounted on a concerned vehicle to prevent erroneous detection against stationary objects such as delineators on guard rails and reflectors on both sides of roads.

Particularly, delineators are frequently placed at equal intervals along roads. Hence, the foregoing estimation of the possibility based on a distance, a difference in relative speeds, and a difference in lateral positions between wave-reflecting objects finds not only a targeted wave-reflecting object but also a further similar wave-reflecting object located closer to the concerned vehicle than the targeted wave-reflecting object. In such a case, an assumption can be made such there is a high possibility that, of two adjacent delineators, one located farther than the other is a large-scale vehicle's cabin. This is undesirable because the processing for counting the cabin counter CA operates, causing an erroneous estimation of the possibility and an unnecessary calculation in the radar device 10.

However, when the speed of a detected wave-reflecting object is smaller than a predetermined value, this object is removed in advance from the consideration. Accordingly, this makes the radar device 10 avoid from misunderstanding that the stationary objects are large-scale vehicles' cabins and lessens the calculation load in the radar device 10.
(3) In the foregoing embodiment, the possibility that a wave-reflecting object has been detected on a reflected wave from a large-scale vehicle's cabin is estimated based on the different-amount parameters of the relative speed difference, lateral position difference, and distance between wave-reflecting objects. The different amounts of the parameters promise to give more accuracy to the estimation.
(4) Further, in the forgoing embodiment, a plurality of different amounts (i.e., determining conditions) are given to each of the relative speed difference, lateral position difference, and distance between wave-reflecting objects in such a manner that the different amounts show different levels of the possibility. Hence the estimation can be resulted in a quantitative manner.
(5) Still further, in the foregoing embodiment, each wave-reflecting object being determined is assigned to a further type of estimation based on positional relationships between a concerned vehicle and each object, provided that each object fails to meet the above determining conditions of the parameters defined between wave-reflecting objects. By applying this further type of estimation to a wave-reflecting object being determined, estimated also is a probability that only the cabin of a large-scale vehicle is located within the detection range of the radar device 10 and the object now being determined has been detected on an electromagnetic wave reflected from the cabin. Thus if a wave-reflecting object being determined is located in a central area of the detection range of the radar device 10, it can be estimated that the possibility that the object being determined is a large-scale vehicle's cabin is low. This upgrades the estimation remarkably.
   (Modifications)

A various types of modifications according to the above embodiment can still be provided, some of which are as follow.

(First Modification)

A first modification relates to the cabin counter CA to count the value indicative of the foregoing possibility.

The determining processing in the foregoing embodiment is programmed to repeat the processing at intervals of 100 msec. Hence if a wave-reflecting object being determined satisfies the determining condition “C” or the determining conditions “E” and “F” sequentially during a predetermined period of time, the cabin counter CA assigned to the object being determined is obliged to be on the decrease.

In such a case, a lower limit can be given to the count of the cabin counter CA. When the count reaches a predetermined value (e.g., −600 corresponding to a period of 10 seconds starting from the initialization of the cabin counter CA), a wave-reflecting object measured by the count of the cabin counter CA is forcibly decided as being an object recognized on a reflected wave from the rear part of a vehicle. On performing such a decision, the object being determined is released from the determining processing and transmission of object data thereof to the computer 4 is started.

For instance, the above processing can be applied to a situation where a first passenger vehicle running ahead of a concerned vehicle along the same lane changes to an adjacent lane and runs ahead of a second passenger vehicle. In this case, the first passenger vehicle is not a large-scale vehicle's cabin, but the determining processing is still carried out based on a distance between a combination of the lane-changed first and second passenger vehicles and the concerned vehicle, a difference in relative speeds between both the passenger vehicles and the concerned vehicle, and a difference in lateral positions between both the vehicles and the concerned vehicle.

Hence, in cases where the determining condition D or the determining conditions E and F are met by a wave-reflecting object being determined without rest during a predetermined period of time, a decision is made such that the object being determined has been recognized on a reflected wave from the rear part of a vehicle. On making the decision that way, the object being determined is removed from a group of objects being determined which are going to be determined from now on, and the object data of the removed object is sent to the computer 4.

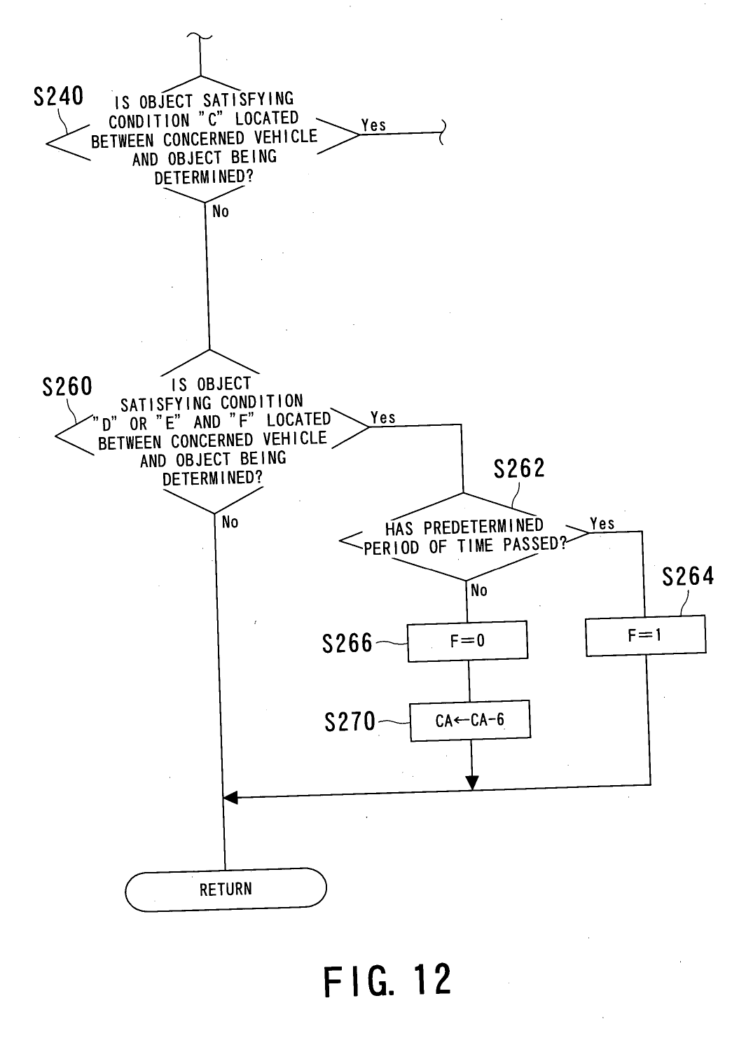

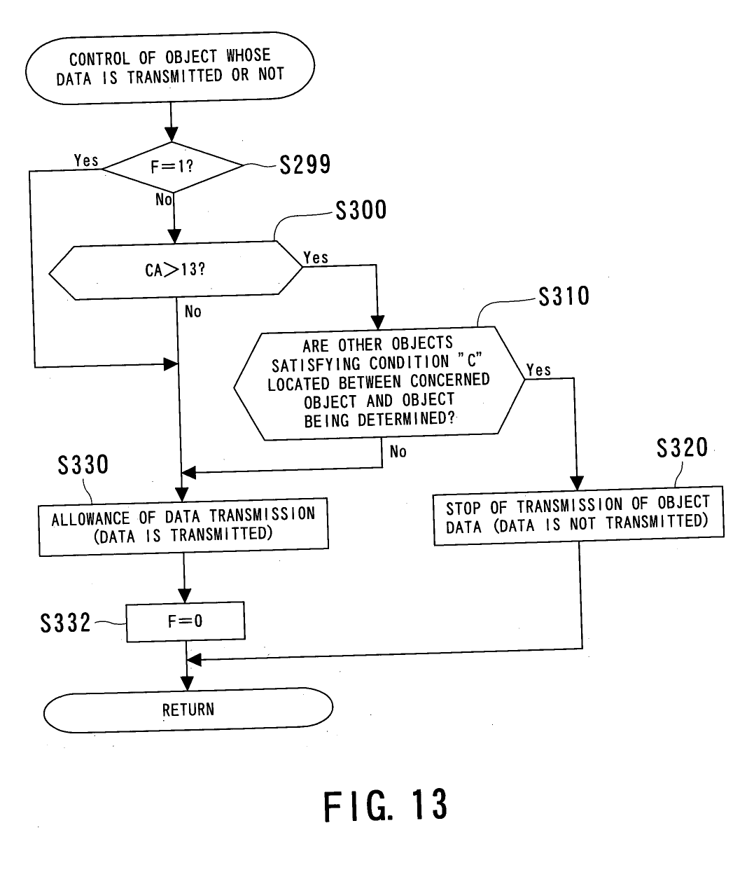

How to perform the processing for the time control is exemplified in FIGS. 12 and 13. In FIG. 12, in the radar device 10, the processing circuit 107 uses a flag “F” showing whether or not a predetermined period of time has passed from the temporal instant when the determination at step S260 has became affirmative (YES). The steps S240, S260 and S270 shown in FIG. 12 are the same as those in FIG. 8.

When it is determined YES at step S260, the processing is then shifted to step S262, where it is further determined whether or not a predetermined period of time (for example, 10 seconds) has passed. If the determination at step S262 is NO, the fag F is kept to “0” to show that the predetermined period of time has not passed yet. In contrast, the determination at step S262 is YES, the flag F is turned to “1”, showing that the predetermined period of time has passed.

This flag control is still inserted in the processing shown in FIG. 13, which is almost the same as that shown in FIG. 9 except that steps S299 and S332 are added. The process at step S299 is placed before step S300 to determine whether or not the flag “F” is now “1.” If the flag “F” is 1 (YES), the processing is skipped to step S330, where the corresponding object data is allowed to be sent to the computer 4. After this data transmission, at step S332, the flag “F” is initialized to “0” to measure the predetermined period of time in the next place.

Hence, the above time control is particularly effective for a situation where two vehicles run temporarily or for a long time with one followed by the other. That is, in such a running situation, a preceding vehicle can be avoided from being captured for the determining processing (i.e., the object data of the preceding vehicle can finally be used for the control).

(Second Modification)

A second modification is concerned with the determining conditions A to C to be prepared for the cabin counter adding/subtracting processing.

In the foregoing embodiment, each of the determining conditions A to C is composed of the determining parameters of the relative speed difference, lateral position difference, and variable distance range Za and the determination of whether or not all the determining conditions are met has been necessary. However, this is not a decisive list, but any one or two of the determining parameters may be used for determination in each of the determining conditions A to C.

(Third Modification)

A third modification relates to variations of the radar device 10 that uses electromagnetic wave such as millimeter wave. The radar device 10 may be replaced by any other means such as laser light or ultrasound wave.

(Fourth Modification)

For instance, part or all of the processing carried out by the processing circuit 107 of the radar device 10 can be replaced by the processing carried out by the computer 4. In such a case, object data corresponding to a higher possibility that a wave-reflecting object being determined is a large-scale vehicle's cabin is blocked from being sent to the various types of running control carried out by the computer 4.

The present invention may be embodied in other specific forms without departing from the spirit or essential characteristics thereof. The present embodiment and modifications are therefore to be considered in all respects as illustrative and not restrictive, the scope of the present invention being indicated by the appended claims rather than by the foregoing description and all changes which come within the meaning and range of equivalency of the claims are therefore intended to be embraced therein.

1. An apparatus for recognizing an object, the apparatus being mounted on a first vehicle, the apparatus comprising:
a transmission/reception unit transmitting a medium wave toward a desired directional range from the vehicle and receiving reflected waves of the medium wave;
a detection unit detecting one or more objects existing in the desired directional range on the basis of the reflected wave, the objects reflecting the medium wave to form the reflected waves;
an estimation unit estimating a possibility that each of the detected object is detected based on a reflected wave from a first part of a second vehicle other than a second part of the second vehicle, the first part being other than the second part that is the closest in distance to the first vehicle; and
a specification unit specifying the second part as an object to finally be recognized of the second vehicle depending on an estimated result by the estimation unit.

2. The apparatus according to claim 1, wherein the detection unit is configured to detect, as the objects existing in the desired direction range, a plurality of objects and to detect a distance from the first vehicle to the detected object, a relative speed to the detected object compared to the first vehicle, and a lateral position of the detected object from the first vehicle to calculate a distance, a difference in a relative speed, and a difference in a lateral position between two objects of the plurality of objects and
the estimation unit includes a first determining unit determining the possibility, as to each of the plurality of objects, on the basis of at least one of the distance, the difference in the relative speed, and the difference in the lateral position between the two objects.

3. The apparatus according to claim 2, wherein the estimation unit is configured to remove, from the plurality of objects detected by the detection unit, an object whose speed is less than a predetermined value.

4. The apparatus according to claim 2, wherein the first determination unit is configured to use, in the estimation, the difference in the relative speed between two objects of the plurality of objects so that the smaller the difference in the relative speed, the higher the possibility to the one of the plurality of objects.

5. The apparatus according to claim 2, wherein the first determination unit is configured to use, in the estimation, the difference in the lateral position between two objects of the plurality of objects so that the smaller the difference in the lateral position, the higher the possibility to the one of the plurality of objects.

6. The apparatus according to claim 2, wherein the first determination unit is configured to use, in the estimation, the distance between two objects of the plurality of objects so that, when the distance is less than a predetermined distance, the possibility to the one of the plurality of objects is high.

7. The apparatus according to claim 6, wherein the predetermined distance is adjustable depending on a degree of a speed of each object being estimated.

8. The apparatus according to claim 4, wherein the first determination unit is configured to use, in the estimation, a plurality of determining conditions respectively depending on mutually different amounts of the difference in the relative speed, the mutually different amounts respectively corresponding to degrees of the possibility different from each other.

9. The apparatus according to claim 5, wherein the first determination unit is configured to use, in the estimation, a plurality of determining conditions respectively depending on mutually different amounts of the difference in the lateral position, the mutually different amounts respectively corresponding to degrees of the possibility different from each other.

10. The apparatus according to claim 6, wherein the first determination unit is configured to use, in the estimation, a plurality of determining conditions respectively depending on mutually different amounts of the distance, the mutually different amounts respectively corresponding to degrees of the possibility different from each other.

11. The apparatus according to claim 2, wherein, when the first determination unit estimates that, of the plurality of objects, an object has the possibility larger than a predetermined level, the specification unit is configured to remove, from the object to finally be recognized, the object having the possibility larger than the predetermined level.

12. The apparatus according to claim 2, wherein the first determination unit is configured to determine whether or not each of the plurality of objects satisfy predetermined determining conditions in relation to the distance, the difference in the relative speed, and the difference in the lateral position between the two objects of the plurality of objects.

13. The apparatus according to claim 12, wherein the estimation unit includes a second determination unit determining, to estimate the possibility, whether or not each of the plurality of objects meets predetermined determining conditions showing positional relationships between the first vehicle and each of the plurality of objects when the first estimation unit determines that an object of the plurality of objects fails to meet the determining conditions of at least one of the distance, the difference in the relative speed, and the difference in the lateral position and
the specification unit is configured to specify the object as the object to finally be recognized, when the second determination unit determines that the object meets the determining conditions showing positional relationships between the first vehicle and each of the plurality of objects.

14. The apparatus according to claim 13, wherein the estimation unit includes a third determination unit determining, to estimate the possibility, whether or not an object of the plurality of objects is continuously subjected to the determination of the second determination unit for a predetermined period of time,
the specification unit is configured to specify the object as the object to finally be recognized, when the third determination unit determines that the object is continuously subjected to the determination of the second determination unit for the predetermined period of time.

15. A method for recognizing an object viewed from a first vehicle, comprising:
transmitting a medium wave toward a desired directional range from the first vehicle and receiving reflected waves of the medium wave;
detecting one or more objects existing in the desired directional range on the basis of the reflected wave, the objects reflecting the medium wave to form the reflected waves;
estimating a possibility that each of the detected object is detected based on a reflected wave from a first part of a second vehicle other than a second object of the second vehicle, the first part being other than the second part that is the closest in distance to the first vehicle; and
specifying the second part as an object to finally be recognized of the second vehicle depending on an estimated result in the estimating step.

16. An apparatus for recognizing an object, the apparatus being mounted on a vehicle, the apparatus comprising:
sensing means for transmitting a medium wave toward a desired directional range from the vehicle and receiving reflected waves of the medium wave;
detection means for detecting one or more objects existing in the desired directional range on the basis of the reflected wave, the object reflecting the medium wave to form the reflected waves;
estimation means for estimating an accuracy that each of the detected objects is a predetermined object in the desired directional range; and
specification means for specifying that the detected object is the predetermined object depending on an estimated result by the estimation means.

17. The apparatus according to claim 16, wherein the specification means includes means for removing data of the object from data to be processed for recognition in cases where the accuracy estimated by the estimation means is lower than a predetermined level.

18. The apparatus according to claim 17, wherein the estimation means includes
first determination means for determining whether or not an object to be determined of the plurality of objects satisfies first determining conditions defining relative positional and running-state relationships between two objects, the first determining conditions being made relevant to the accuracy, and
second determination means for determining whether or not the object to be determined satisfies second determining conditions defining positional relationships, the second determining conditions being made relevant to the accuracy, when the first determination means determines that the object to be determined fails to meet the first determining conditions.
